(19) United States
(12) Patent Application Publication
(10) Pub. No.: US 2023/0012039 A1
(43) Pub. Date: Jan. 12, 2023

(54) DISPOSABLE MIXER WITH SYRINGE WITHDRAWAL

(71) Applicant: BORMIOLI PHARMA S.P.A., 20123 MILANO (IT)

(72) Inventors: LORENZO RUGGIERI, MILANO (IT); RICCARDO TRABATTONI, SEREGNO (IT); ANDREA MALDIFASSI, SARONNO (IT); MATTEO AGATI, SARONNO (IT)

(21) Appl. No.: 17/763,967

(22) PCT Filed: Sep. 23, 2020
(86) PCT No.: PCT/IB2020/058895

§ 371 Date: Mar. 25, 2022

(30) Foreign Application Priority Data
Oct. 30, 2019 (IT) 102019000020108

(51) Int. Cl. A61J 1/20

(52) U.S. Cl. CPC A61J 1/2089; A61J 1/2013; A61J 1/2096; A61J 1/2051

(57) ABSTRACT

A system for the preparation and dispensing of a mixture comprising: i) a container (2) for a first substance; ii) a closure cap (4) of the container (2); iii) a capsule (3) applied to a mouth (20) of the container (2) and comprising: —a containment chamber (31) for the second substance; —a perforation means (32) for perforating the chamber (31) and the cap (4); said system (1) taking on a rest configuration wherein the inside of the container (2) and the inside of the containment chamber (31) are fluid-dynamically separated and an operating configuration wherein said perforation means (32) extends into the chamber (31) and passes through the cap (4); iv) a mixture withdrawal mouth (5) which is part of said container (2) or of said capsule (3); said withdrawal mouth (5) being intended to dispense the mixture of the first and second substances outside the system. The cap (4) may or may not be part of the capsule (3). A movement of said chamber (31) brings about the passage from the rest configuration to the operating configuration; said perforation means (32) comprising a conduit (320) which in said operating configuration places the inside of the container (2) in communication with the inside of the chamber (31). The withdrawal mouth (5) in the rest configuration, is in fluid communication with the chamber (31) or the container (2).

### TECHNICAL FIELD

The subject matter of the present invention is a system and a method for preparing and dispensing a mixture of a first and a second substance. Typically such system is used in pharmaceutical applications. In particular, such system is used for keeping two substances separate and enabling them to be mixed only shortly prior to administration. This is for the purpose of preventing a mixture of the two substances being able to alter the chemical/physical properties of at least one of the two substances. Therefore, this enables the shelf life to be increased.

### BACKGROUND ART

A solution of the type described in EP1631231 is known. It describes a technical solution comprising a central body equipped with corresponding perforators. Two distinct vials can be connected to the central body on opposite sides. Through the perforators it is possible to open corresponding vial closure lids. The central body is provided with a side surface comprising a valve through which it is possible to withdraw the mixture by means of a syringe. Only after opening the closure lids, through a channel afforded in said perforators, the channel can be connected to the vials in order to enable the dispensing of the mixture.

A drawback of such solution is connected with the fact that it requires the connection of two vials to the central body thus compromising the sterility of the system. A further drawback is connected with the construction complexity of the shearer defined by a small element crossed internally by a plurality of small conduits and telescopic bodies (difficult to create or assemble because of their small dimensions).

### DISCLOSURE OF THE INVENTION

In this context, the technical task underlying the present invention is to offer a system for preparing and dispensing a mixture that makes it possible to overcome the drawbacks described hereinabove. In particular, the object of the present invention is to provide a system for preparing and dispensing a mixture that allows maximum ergonomics and enables the components to be optimised while containing the costs. A further important advantage is the possibility to obtain a sterile mixture.

The technical task set and the objects specified are substantially attained by a system, comprising the technical characteristics as set out in one or more of the accompanying claims.

### BRIEF DESCRIPTION OF DRAWINGS

Further characteristics and advantages of the present invention will become more apparent from the indicative and thus non-limiting description of a preferred but not exclusive embodiment of a capsule, as schematically illustrated in the appended drawings, in which:

FIG. 1 shows a sectional view of a system according to the present invention;

FIGS. 1a and 1b show two details of FIG. 1;

FIGS. 2, 3 and 4 show a portion of the system of FIG. 1 in three subsequent configurations;

FIGS. 5, 6 and 7 show a sectional view of the system of FIG. 1 in three subsequent configurations.

### DETAILED DESCRIPTION OF PREFERRED EMBODIMENTS OF THE INVENTION

In the appended figures, the reference number 1 indicates a system for preparing and dispensing a mixture of at least a first and a second substance.

The system 1 comprises a container 2 of the first substance. Such first substance may for example be liquid. The container 2 may for example be a vial. For example, it may be made of a glass or plastic material.

The system 1 further comprises a closure cap 4 of the container 2. Advantageously, as will become clearer below such cap 4 can be perforated. This takes place irreversibly. For example it is a membrane. It could be made of plastic or elastomeric material.

The system 1 further comprises a capsule 3. Such capsule 3 is appropriately applied to a mouth 20 of the container 2. Typically, such mouth 20 is at one end of a neck of the container 2.

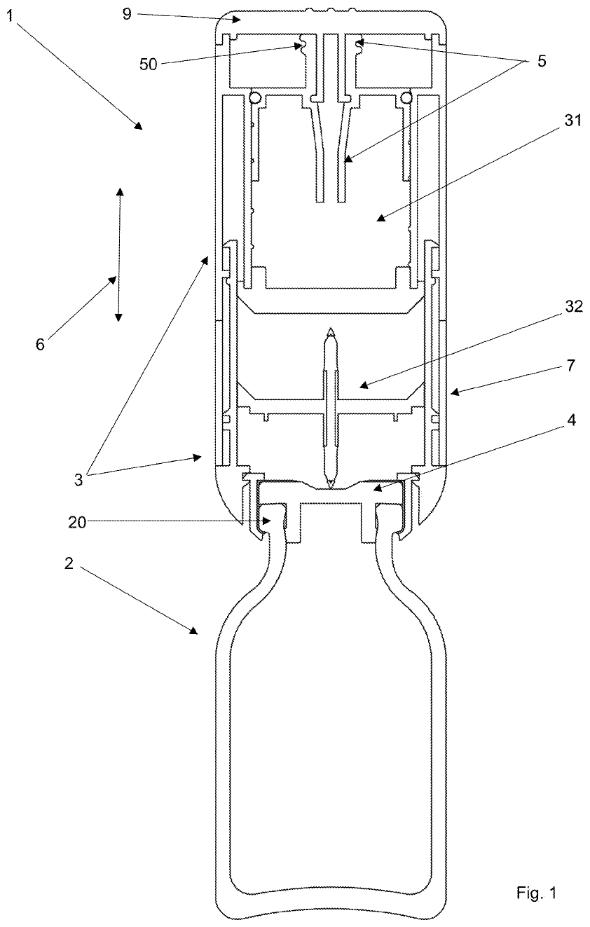

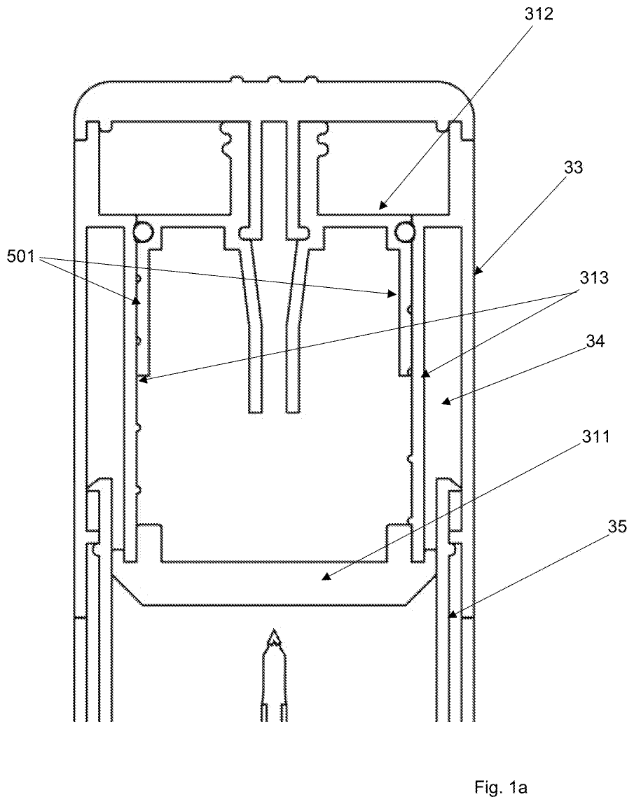

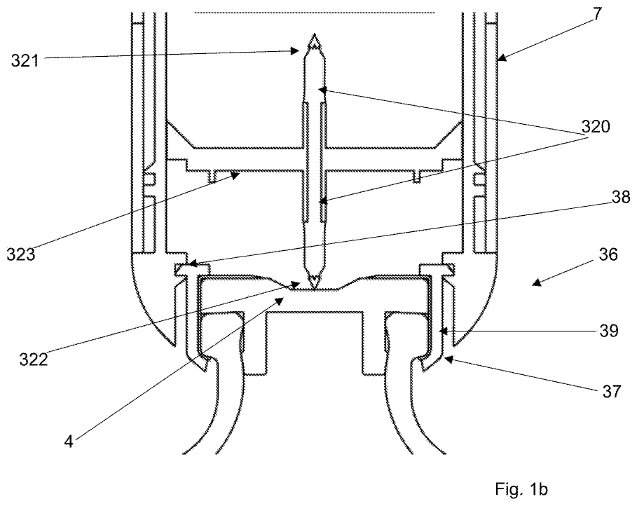

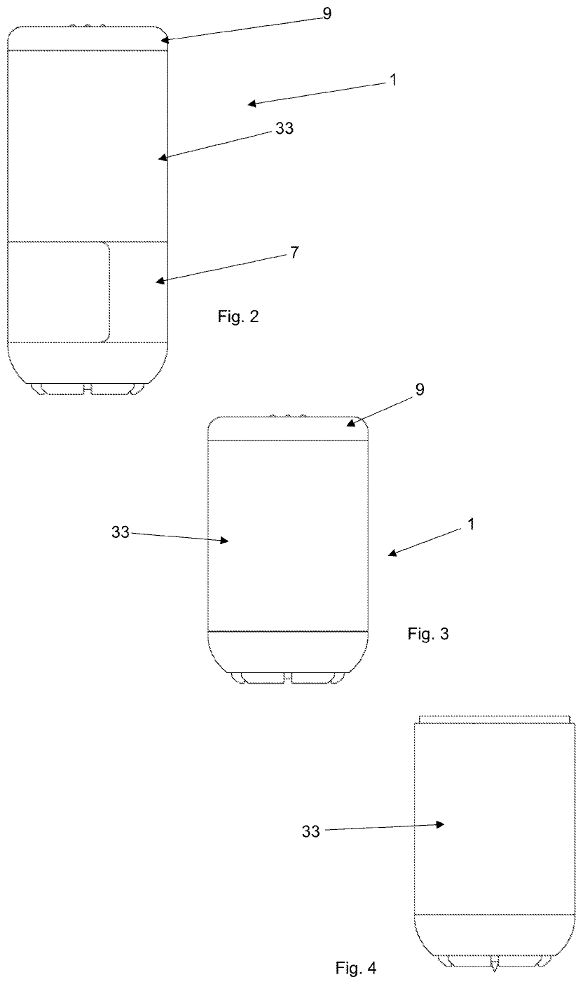

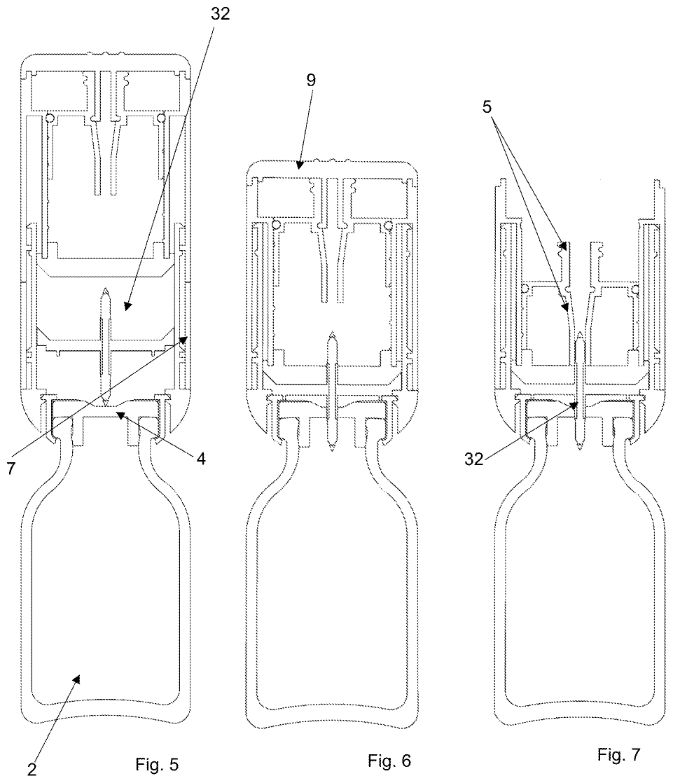

The container 2 and the capsule 3 are advantageously pre-assembled. Appropriately the capsule 3 comprises a containment chamber 31 for the second substance. Such second substance is for example a solute. It could be a granular or a powdered element. The second substance is intended to be mixed with the first substance prior to administration. The capsule 3 further comprises a perforation means 32 for perforating the chamber 31 and the cap 4. The system 1 is therefore able to take on a rest configuration (see for example FIGS. 1 and 5) wherein the inside of the container 2 and the inside of the containment chamber 31 are fluid-dynamically separated. In that case the cap 4 and the chamber 31 are intact (not perforated). The perforation means 32 is preferably partly opposite the cap 4 and partly in the chamber 31. The system 1 can also take on an operating configuration wherein the perforation means 32 extends into the chamber 31 and passes through the cap 4 (see for example FIG. 6). The operating configuration can also be defined as a mixing configuration of the first and the second substances.

The rest configuration is the normal configuration of the system 1; shortly prior to administration the system takes on the operating configuration enabling the mixing of the first and the second substances.

Furthermore, the system 1 also comprises a withdrawal mouth 5. The withdrawal mouth 5 is intended to dispense the mixture of the first and second substances. The withdrawal mouth 5 may be part of the capsule 3 (as in the solution illustrated in the appended figures). It could possibly also be part of the container 2 (not a preferred solution, as the containers are usually containers of the standard type). However, in that case it is advantageously distinct from the mouth 20. As exemplified in the appended figures, the withdrawal mouth 5 may be a tubular element.

The withdrawal mouth 5, in the rest configuration, is in fluid communication with the chamber 31. In particular, the withdrawal mouth 5 is part of the chamber 31. This means that the withdrawal mouth 5 is afforded along a wall that delimits the chamber 31. Preferably the chamber 31 comprises:
a portion 311 intended to be perforated by the perforation means 32; the portion 311 is irreversibly perforable;
a bottom 312 opposite the perforable portion 311;
an intermediate lateral side 313.

Appropriately, the withdrawal mouth 5 is afforded in a zone opposite the perforable portion 311. Appropriately, the mouth 5 is on the bottom 312 of the chamber 31. The perforable portion 311 is appropriately a membrane. The perforable portion 311 may for example be made of elastomeric or plastic material.

In the preferred solution the withdrawal mouth 5 comprises an attachment 50 which is typically threaded for the connection with a withdrawal syringe. Such attachment 50 defines a spout which projects with respect to the chamber 31.

The capsule 3 appropriately comprises an openable lid 9 for closing the withdrawal mouth 5. It is located in a zone of the capsule 3 opposite the container 2. Appropriately the closure lid 9 is applied to the chamber 31. By way of example it extends partly into the withdrawal mouth 5. Advantageously the lid 9 is connected to the chamber 31 by elastic deformation. Preferably the lid 9 is fully removable. Appropriately the lid 9 fully covers a face of the capsule 3 opposite a connection zone with the container 2. The lid 9 is appropriately made of a plastic material.

Preferably, but not necessarily, the withdrawal mouth 5 can move (in particular translate) along the mixing direction 6 (in particular after the removal of the lid 9). In particular, the withdrawal mouth 5 can move along the direction 6 towards the perforable portion 311 (and therefore moving appropriately towards the container 2). Appropriately in this way the system 1 can take on a dispensing configuration in which the perforation means 32 (and therefore advantageously the conduit 320 better defined below) extends into the withdrawal mouth 5 (see for example FIG. 7). In the dispensing configuration the withdrawal mouth 5 is abutted by the perforable portion 311. Possibly in a non-preferred solution the dispensing of the product could be possible also without the movement of the perforation mouth 5 towards the perforable portion 311. Appropriately an annular portion 501 integral with the withdrawal mouth 5 is overlapped at least in part with the lateral side 313. In the dispensing configuration said annular portion 501 and the lateral side 313 interact mechanically by means of at least one projection and a corresponding seat.

Still with reference to the illustrated solution, in the appended figures the cap 4 is part of the capsule 3. However, it may not be part of it. For example, it could be part of the container 2.

The passage from the rest configuration to the operating configuration is enabled by a predetermined movement of the chamber 31. Appropriately such movement is a translation. Such movement must be greater than a minimum stroke to enable the means 32 to perforate the chamber 31 and through the cap 4. By way of non-limiting example, such minimum stroke is greater than 2 centimetres and/or less than 5 centimetres.

The perforation means 32 comprises a conduit 320 which in the operating configuration places in communication the inside of the container 2 and the inside of the chamber 31. Appropriately in the operating configuration the conduit 320 extends into the container 2 and the chamber 31. The movement of the chamber 31 for passing from the rest configuration to the operating configuration takes place along a mixing direction 6. The perforation means 32 of the chamber 31 and of the cap 4 in the rest configuration is interposed between the chamber 31 and the cap 4 along the mixing direction 6. Therefore during the movement of the chamber 31, the perforation means 32 brings about the perforation of the chamber 31 itself.

Appropriately the perforation means 32 is movable along the mixing direction 6. This enables, for example, a movement thereof under the thrust of the chamber 31. In this way it can also come into contact with the cap 4 for enabling the perforation thereof.

In the preferred solution, the perforation means 32 comprises:
a first perforator 321 which, in the rest configuration, is oriented (i.e. it extends) towards the chamber 31;
a second perforator 322 which, in the rest configuration, is oriented (i.e. it extends) towards the cap 4.

The first perforator 321 is therefore intended to perforate the chamber 31. The second perforator 322 is intended to open the cap 4.

Appropriately the means 32 comprises an intermediate plate 323 with respect to which the first and the second perforator 321, 322 extend along opposite directions. Appropriately, the first and the second perforator 321, 322 are coaxial. Appropriately, the first and the second perforator 321, 322 extend from a central zone of the plate 323. They extend along a movement direction of the chamber 31. The conduit 320 extends at least in part inside the first and the second perforator 321, 322. Appropriately such conduit 320 also crosses the plate 323. Appropriately the conduit 320 is a rectilinear channel.

Preferably, the perforation means 32 comprises a single piece that comprises both the first and the second perforator 321, 322. For example, the perforation means 32 comprises a single piece made of plastic material (typically monolithic).

The capsule 3 comprises a wall 33 that surrounds the chamber 31. Appropriately, the wall 33 is annular. Advantageously, a space 34 is defined between the wall 33 and the chamber 31.

The capsule 3 also comprises a telescopic side 35.

The telescopic side 35, in the operating configuration, extends into the space 34 to a greater extent with respect to when it is in the rest configuration. In the rest configuration the telescopic side 35 can extend more or less into the space 34.

The perforation means 32 is slidable along the telescopic side 35 during the movement from the rest configuration to the operating configuration.

As previously explained, this happens by means of the thrust caused by the chamber 31. The perforation means 32 therefore translates along the telescopic side 35 during the movement from the rest configuration to the operating configuration. In particular, the plate 323 of the perforation means 32 is placed in contact internally with the telescopic side 35 along such side 35.

The system 1 is disposable.

The system 1 comprises a removable anti-tampering seal 7. Typically, there is a single anti-tamper seal 7. The seal 7, if provided, defines an abutment that prevents the passage from the rest configuration to the operating configuration. The seal 7 is for example an annular element. If provided, it wraps the telescopic side 35 for example. The seal 7, if removed, enables the passage from the rest configuration to the operating configuration.

The capsule 3 further comprises an engagement means 36 with the container 2. The engagement means 36 comprises, for example, a retaining means 37 of the container 2. Appropriately, the retaining means 37 is connected to the telescopic side 35 (appropriately at an end of the telescopic side 35). The telescopic side 35 may for example comprise a groove 38 in which the retaining means 37 is engaged. The retaining means 37 can for example comprise an annular band 39 which grips onto the container 2 (in particular to a neck of the container 2). The retaining means 37 also retains the cap 4 pressed against the container 2 (in particular against the neck of the container 2).

The subject matter of the present invention is also a method for dispensing the mixture of the first and second substances. This is obtained using for example a system 1 that has one or more of the characteristics described above.

Appropriately, the method comprises the step of moving the chamber 31 closer to the container 2. In doing so, the perforation means 32 perforates the cap 4 and the containment chamber 31 placing in fluid communication the inside of the chamber 31 and of the container 2 (see the step from FIG. 5 to FIG. 6). The step of moving the chamber 31 closer to the container comprises the step of pushing the capsule 3 towards the container 2 (appropriately the latter will be on a rest so as to facilitate the ergonomics and enable the use also with one hand only). During the step of moving the chamber 31 closer to the container 2 the perforation means 32 initially comes into contact with a perforable portion of the chamber 31. Furthermore, during the step of moving the chamber 31 towards the container, the chamber 31 pushes the perforation means 32 against the cap 4. This causes the perforation of the cap 4. Preferably, the perforation of the perforable portion 311 takes place at the same time as the step of perforating the cap 4 or prior to it. The perforation means 32 defines an inner conduit 320. The first and the second substances are therefore in fluid communication and can mix. Preferably, in order to mix, the second substance crosses the conduit 320 defined by the perforation means 32 and flows into the container 2 and/or vice versa.

The method therefore comprises the step of mixing the first substance placed in the containment chamber 31 with the second substance placed in the container 2.

The method further comprises the step of withdrawing the mixture of the first and second substances by means of a syringe applied to the withdrawal mouth 5. The withdrawal mouth 5 is advantageously afforded along the containment chamber 31. In particular, the withdrawal mouth 5 is placed along a portion of the chamber 31 which is further away from the container 2. To allow the step of withdrawing the mixture of the first and second substances through the syringe the system 1 is placed so that the dispensing mouth 5 is below the container 2 and the mixture flows by gravity towards the dispensing mouth 5. Appropriately, before withdrawing the mixture of the first and second substances by means of a syringe, the method comprises the step of pushing the withdrawal mouth 5 towards the container 2 (and in particular towards the perforable portion 311). In this way the perforation means 32 extends into the withdrawal mouth 5 (in fact, the withdrawal mouth 5 preferably defines a tubular element). In this way the mixture can pass from the container 2 to the dispensing mouth (advantageously directly) through the channel 320 of the perforation means 32.

The present invention achieves important advantages.

First of all it enables the shape of the components to be optimised enabling easy assembly and at the same time creating a strong and reliable structure. Furthermore this allows the optimisation of the components to enable the costs to be contained.

The invention thus conceived is susceptible of numerous modifications and variants, all falling within the scope of the inventive concept which characterises it. Further, all the details can be replaced with other technically equivalent elements. In practice, all the materials used, as well as the dimensions, can be any according to requirements.

1. A system for preparing and dispensing a mixture of at least a first and a second substance comprising:
i) a container (2) for the first substance;
ii) a closure cap (4) of the container (2);
iii) a capsule (3) applied to a mouth (20) of the container (2) and comprising:
a containment chamber (31) for the second substance;
a perforation means (32) for perforating the chamber (31) and the cap (4); said system (1) taking on a rest configuration wherein the inside of the container (2) and the inside of the containment chamber (31) are fluid-dynamically separated and an operating configuration wherein said perforation means (32) extends into the chamber (31) and passes through the cap (4);
iv) a mixture withdrawal mouth (5) which is part of said container (2) or of said capsule (3); said withdrawal mouth (5) being intended to dispense the mixture of the first and second substances outside the system;
said cap (4) possibly being or not being part of the capsule (3);
a movement of said chamber (31) bringing about a passage from the rest configuration to the operating configuration; said perforation means (32) comprising a conduit (320) which in said operating configuration places the inside of the container (2) in communication with the inside of the chamber (31);
characterised in that said withdrawal mouth (5), in the rest configuration, is in fluid communication with the chamber (31) or the container (2).

2. The system according to claim 1, characterised in that the passage from the rest configuration to the operating configuration is enabled by a movement of the chamber (31) along a mixing direction (6); said perforation means (32) for perforating the chamber (31) and the cap (4) in the rest configuration is interposed between the chamber (31) and the cap (4) along the mixing direction (6).

3. The system according to claim 2, characterised in that the perforation means (32) is movable along said mixing direction (6).

4. The system according to claim 1, characterised in that the perforation means (32) comprises:
a first perforator (321) which, in the rest configuration, is oriented towards the chamber (31);
a secondo perforator (322) which, in the rest configuration, is oriented towards the cap (4).

5. The system according to claim 4, characterised in that the perforation means (32) comprises a single monolithic piece that comprises both the first and the second perforator (321, 322).

6. The system according to claim 1, characterised in that said capsule (3) comprises:
a wall (33) that surrounds the chamber (31) and defines a space (34) between the wall (33) and the chamber (31);
a telescopic side (35);
said telescopic side (35), in the operating configuration, extending into said space (34) to a greater extent than in the rest configuration; in the rest configuration said telescopic side (35) possibly extending or not extending into said space (34).

7. The system according to claim 6, characterised in that the perforation means (32) is slidable along said telescopic side (35) during the movement from the rest configuration to the operating configuration.

8. The system according to claim 1, characterised in that it comprises a single removable anti-tamper seal (7); said seal (7), if present, defining a barrier that prevents the passage from the rest configuration to the operating configuration; said seal (7), if removed, enabling a passage from the rest configuration to the operating configuration.

9. The system according to claim 1, characterised in that the perforation means (32) comprises a single channel suitable for having a fluid pass through it and coinciding with the conduit (320).

10. A method for dispensing the mixture of the first and second substances using a system (1) according to claim 1, characterised in that it comprises the steps of:
move the chamber (31) closer to the container (2); said perforation means (32) perforating said cap (4) and said containment chamber (31) and placing the inside of the chamber (31) in fluid communication with the container (2);
mixing the first substance placed in the containment chamber (31) with the second substance placed in the container (2);
withdrawing the mixture of the first and second substances by means of a syringe applied to said withdrawal mouth (5).
